(19) United States
(12) Patent Application Publication
(10) Pub. No.: US 2008/0247665 A1
(43) Pub. Date: Oct. 9, 2008

(54) Method and apparatus for dynamic contrast enhancement

(75) Inventor: Jeng-Yun Hsu, Hsin Chu City (TW)

Correspondence Address: Joe McKinney Muncy, PO Box 1364, Fairfax, VA, 22038-1364, US

(73) Assignee: SILICON INTEGRATED SYSTEMS CORP.

(21) Appl. No.: 11/730,860

(22) Filed: Apr. 4, 2007

(51) Int. Cl. G06T 5/40

(52) U.S. Cl. 382/274

(57) ABSTRACT

A method and apparatus for dynamic contrast enhancement is provided. The apparatus at least comprises a histogram calculator, a low-pass filter, a blending unit and a luma remapper. By means of blending a content-based histogram with a user-defined histogram, the invention solves a problem that the mean luma value is shifted too much due to a drastic adjustment.

### BACKGROUND OF THE INVENTION

1. Field of the Invention

The invention relates to dynamic contrast enhancement, and more particularly to a method and apparatus for dynamic contrast enhancement via blending a content-based histogram with a user-defined histogram.

2. Description of the Related Art

Throughout the specification and claims, the following terms take the meanings explicitly associated herein, unless the context dearly dictates otherwise. The term “luma” refers to the component of an input image data value that is correlated to the perceived intensity of a displayed data value. Wherein, the input image data itself may be analog/digital in nature and finally displayed on an analog/digital display such as a CRT/LCD. The term “chroma” refers to the component of the input image data value that is correlated to the perceived color of the displayed data value. Hue and saturation are two commonly used color perception that together define the chroma data. The term “dynamic contrast enhancement” refers to a dynamic adjustment of image luma contrast according to image luma level distribution (histogram). The term “user-defined histogram” refers to a histogram that is pre-defined in advance and/or programmed dynamically in operation.

Since a transfer function is adjusted based on image contents, it is a quite complicated process. A related set of methods for adjusting image contrast have been developed in the field of image processing for image enhancement. Perhaps the best known technique is histogram equalization. Numerous improvements have been made to histogram equalization and can be roughly divided into a curve selection approach and a curve calculation approach. The curve selection approach is to provide a set of predetermined transfer functions in advance and dynamically select one from the predetermined transfer functions according to image contents, such as disclosed in U.S. Pat. No. 5,808,697. However, since the composition of the image is complicated, it is difficult to correctly compensate the image contrast with a single transfer function selected from the predetermined transfer functions, therefore rendering this approach a limited application scope.

The curve calculation approach is simply to perform calculations dynamically to obtain a transfer function instead of selecting one from the predetermined transfer functions. However, this approach generally has a drawback that the mean luma value is generally shifted too much due to a drastic adjustment. For example, an image taken in the night looks like an image taken in the daytime. Besides, this approach also makes gradient changes in luma levels discontinuous. A method relating to this approach is disclosed in a paper, “Contrast enhancement Using Brightness Preserving Bi-Histogram Equalization”, Y.-T. Kim, IEEE Transactions on Consumer Electronics, Vol. 43, No. 1, February 1997. One problem with the Kim's method is that many different image distributions can have the same mean. Another problem is that the mean statistic is extremely sensitive to outliers, i.e., a relatively few pixels with luma levels located far from the mean can have a profound influence on mean luma level.

Accordingly, what is needed is a method and apparatus to address the above-identified problems. The invention addresses such a need.

### SUMMARY OF THE INVENTION

In view of the above-mentioned problems, an object of the invention is to provide an apparatus for dynamic contrast enhancement by means of blending a content-based histogram with a user-defined histogram.

To achieve the above-mentioned object, the dynamic contrast enhancement apparatus comprises: a histogram calculator for calculating a luma histogram for a current frame; a low-pass filter coupled to the histogram calculator for performing a low-pass filtering operation on the luma histogram and generating a filtered histogram; a blending unit coupled to the low-pass filter for blending the filtered histogram with a user-defined histogram and generating a blended histogram according to a blending weight; and, a luma remapper coupled to the blending unit for generating a transfer function according to the blended histogram and applying the transfer function to the current frame.

Another object of the invention is to provide a method for dynamic contrast enhancement by means of blending a content-based histogram with a user-defined histogram. The dynamic contrast enhancement method comprises the steps of: calculating a luma histogram for a current frame; performing a low-pass filtering operation on the luma histogram to generate a filtered histogram; blending the filtered histogram with a user-defined histogram to generate a blended histogram; generating a transfer function according to the blended histogram; and, applying the transfer function to the current frame.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram showing a first embodiment of the invention.

FIG. 2 illustrates a comparison of two resulting transfer functions.

FIG. 3 gives an example of how to blend a filtered histogram with a user-defined histogram into a blended histogram.

FIGS. 4A-4C illustrate three different dgain-ratio relation curves.

FIG. 5 is a block diagram showing a second embodiment of the invention.

FIG. 6 is a block diagram showing a third embodiment of the invention.

FIG. 7A illustrates an exemplary temporal histogram and its corresponding transfer function.

FIG. 7B shows a relation between the chroma gain and the bin index based on the transfer function shown in FIG. 7A.

### DETAILED DESCRIPTION OF THE INVENTION

The method and apparatus for dynamic contrast enhancement of digital images of the invention will be described with reference to the accompanying drawings.

The apparatus in accordance with the present invention may be hardware, software, or a combination of hardware and software (or firmware). An example of a pure solution would be an FPGA or ASIC design. An example of a hardware and software implementation would be a DSP and embedded firmware.

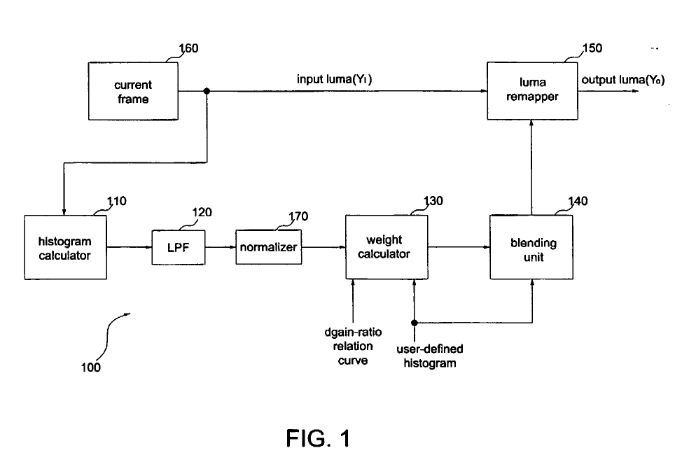

FIG. 1 is a block diagram showing a first embodiment of the invention. Referring to FIG. 1, a dynamic contrast enhancement apparatus 100 comprises a histogram calculator 110, a low-pass filter 120, a weight calculator 130, a blending unit 140, a normalizer 170 and a luma remapper 150. Concerning a current frame 160 made of a plurality of input image data (or pixels), each input image data value is separated into its luma and chroma components. After collecting all the luma data, the histogram calculator 110 calculates a luma histogram for the current frame.

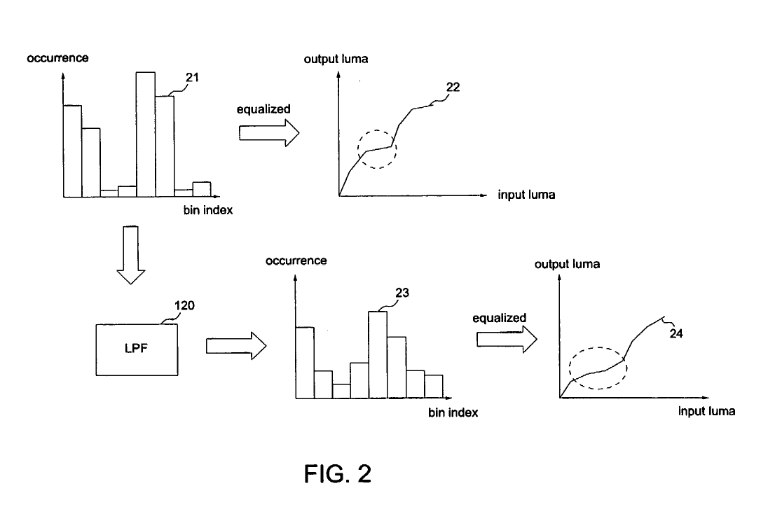

After receiving the luma histogram, the low-pass filter 120 performs a low-pass filtering operation on the luma histogram to generate a filtered histogram. FIG. 2 illustrates a comparison of two resulting transfer functions. A transfer function 22 is obtained after a luma histogram 21 is equalized but not performed a low-pass filtering operation. In comparison, a transfer function 24 is obtained after the luma histogram 21 is provided to the low-pass filter 120 to produce a filtered histogram 23 and then the filtered histogram 23 is equalized. Comparing two transfer functions 22, 24, it is obvious that there are more discontinuous gradient changes in the transfer function 22 than in the transfer function 24. In other words, more gradient patterns can be preserved in the transfer function 24 than in the transfer function 22, which also improves accurate determination of a dynamic blending weight (which will be described later).

According to the invention, the user-defined histogram can be pre-defined in advance and/or programmed dynamically in operation. For example, a user can assign an individual magnitude for each bin (histograms are made up of bins, each bin representing a certain luma level range) to construct a user-defined histogram in advance. In order to blend the filtered histogram with the user-defined histogram, both histograms must be normalized to the same reference, e.g., 256 (the whole luma level range), before sent into the weight calculator 130. In this way, the filtered histogram adds up to the total number of pixels (btotal). The normalization performed by a normalizer 170 is to scale the filtered histogram from a cumulative total of btotal to 256. For example, if L (the total number of luma levels)=256 and bsize (the number of bins)=8, then each bin width=32 luma levels. Firstly, the normalizer 170 calculates

$$btotal = {\sum }_{0}^{bsize - 1} bin ( i ) ,$$

where bin(i) is the count of bin i in the filtered histogram and btotal is the total number of pixels in the filtered histogram. Then, the normalizer 170 normalizes the magnitude of each bin by calculating bin(i)=(bin (i)×L÷btotal), where i is a positive integer and covers the range form 1 to (bsize−1). Note that the normalizer 170 can be omitted if the filtered histogram and the user-defined histogram already have the same reference, i.e., the same luma level range.

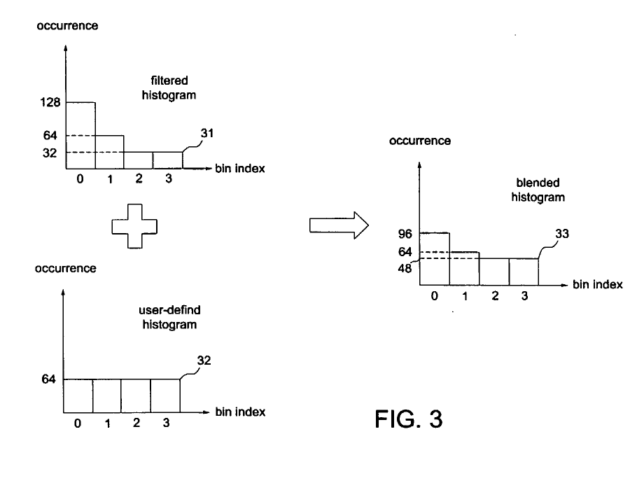

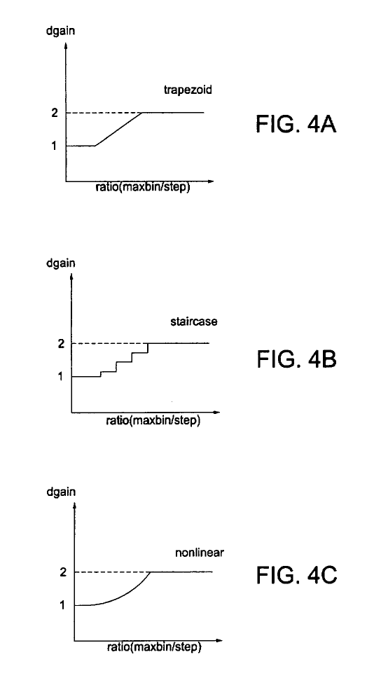

The weight calculator 130 receives the filtered histogram and dynamically generates a blending weight sw according to the filtered histogram, a user-defined histogram and a pre-defined dgain-ratio relation curve (which will be described later). The blending unit 140 blends the filtered histogram with the user-defined histogram according to the blending weight value sw and then generates a blended histogram. FIG. 3 gives an example of how to blend a filtered histogram with a user-defined histogram into a blended histogram. The following example is used to describe the operations of the weight calculator 130 and the blending unit 140 with reference to FIG. 3 and FIGS. 4A-4C, where the total number of luma levels=256, the number of bins=4, and therefore each bin width=64 luma levels.

According to the histograms shown in FIG. 3, the maximum count (hereinafter called “maxbin”) in any one bin of the filtered histogram 31 is 128 and the maximum count (hereinafter called “step”) in any one bin of the user-defined histogram 32 is 64. They (maxbin and step) are all identified by the weight calculator 130.

The weight calculator 130 generates a blending parameter dgain based on one of three dgain-ratio relation curves and a ratio (=maxbin/step). According to the invention, there are three dgain-ratio relation curves in the shapes of trapezoid, staircase and nonlinear as shown in FIGS. 4A˜4C. These three relation curves roughly feature the same tendency. That is, while the ratio (=maxbin/step) gets close to 1, indicating the filtered histogram is similar to the user-defined histogram, the blending parameter dgain is set to 1. As the ratio becomes larger, representing that the blended histogram will be more like the filtered histogram, the blending parameter dgain increases. While the ratio is greater than a threshold value, the blending parameter dgain is set to a constant (e.g., 2 in FIGS. 4A˜4C). However, these three relation curves present different implementation difficulties. The relation curve in the shape of staircase (in FIG. 4B) is the easiest to be implemented while the relation curve in the shape of nonlinear (in FIG. 4C) is the most difficult to be implemented. Suppose dgain(=1.5) is obtained according to the ratio (=maxbin/step=128/64=2, as shown in FIG. 3) and one of three dgain-ratio relation curves as shown in FIGS. 4A˜4C.

Therefore, the weight calculator 130 dynamically determines the blending weight sw based on parameters (maxbin, step and dgain). According to the first embodiment, the following equation is used to determine the blending weight sw

maxbin×sw+step×(1−sw)=dgain×step (A)

The weight calculator 130 simply plugs maxbin=128, step=64 and dgain=1.5 into the equation (A) and therefore obtains sw=0.5. Consequently, the blending unit 140 starts to blend the filtered histogram 31 with the user-defined histogram 32, bin by bin, to construct a blended histogram 33 according to the obtained blending weight sw(=0.5). Thus, the final number of pixels for each bin of the blended histogram 33 can be obtained. For example, 96 (=128×0.5+64×0.5) is the final number of pixels in bin 0 and 64 (=64×0.5+64×0.5) is the final number of pixels in bin 1 of the blended histogram 33, etc. In the equation (A), (dgain×step) is employed to restrict the magnitude of each bin, therefore avoiding a drastic adjustment and over-enhancement of luma contrast.

Finally, after receiving the blended histogram, the luma remapper 170 performs an integration operation to obtain a transfer function. After that, the luma remapper 170 applies the transfer function to the current frame to translate all the luma values.

It should be noted that maxbin and step are not restricted to the maximum counts in the bins of the filtered histogram and the user-defined histogram, respectively maxbin can be selected within a range from the maximum count to the Nₜₕ maximum count in the bins of the filtered histogram, where N is equal to a total number of the bins of the filtered histogram divided by three and N is a positive integer. For example, if the total number of the bins of the filtered histogram is equal to 15, maxbin can be selected within a range from the maximum count to the fifth (N=1513=5) maximum count in the bins of the filtered histogram. Alternatively, maxbin can be a mean of a range from the Mₜₕ maximum count to the Nₜₕ maximum count in the bins of the filtered histogram and N is equal to a total number of the bins in the filtered histogram divided by three, wherein N and M are positive integers and N>M. For example, if M=2 and the total number of the bins of the filtered histogram is equal to 15, maxbin is a mean of a range from the second (M=2) maximum count to the fifth (N=15/3=5) maximum count in the bins of the filtered histogram. Likewise, step can be selected within a range from the maximum count to the Pₜₕ maximum count in the bins of the user-defined histogram, where P is equal to a total number of bins of the user-defined histogram divided by three and P is a positive integer. Alternatively, step can be a mean of a range from the Qₜₕ maximum count to the Pₜₕ maximum count in the bins of the user-defined histogram and P is equal to a total number of the bins in the user-defined histogram divided by three, where Q and P are positive integers and P>Q.

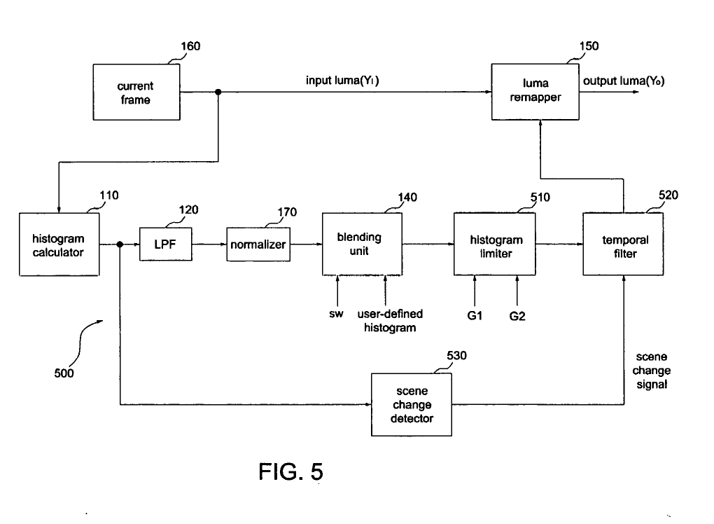

FIG. 5 is a block diagram showing a second embodiment of the invention. Referring to FIG. 5, a dynamic contrast enhancement apparatus 500 comprises a histogram calculator 110, a low-pass filter 120, a blending unit 140, a histogram limiter 510, a temporal filter 520, a luma remapper 150, a normalizer 170 and a scene detector 530. Compared with the first embodiment, the dynamic contrast enhancement apparatus 500 in the second embodiment deletes the weight calculator 130 and additionally includes the histogram limiter 510, the temporal filter 520 and the scene detector 530. The same numerals are used for components identical to the first embodiment, and repeated description is omitted.

In the second embodiment, the blending unit 140 blends the filtered histogram with the user-defined histogram, bin by bin, to construct a blended histogram according to a static (or fixed) blending weight sw. That is, bin_{b}(i)=bin_{f}(i)×sw+bin_{U}(i)×(1−sw), where bin_{b}(i), bin_{f}(i) and bin_{U}(i) are the counts in bin i of the blended histogram, the filtered histogram, the user-defined histogram, respectively. In order to prevent dramatic luma change of the histogram distribution, the histogram limiter 510 is required after the blending unit 140 performs a static blending operation. The histogram limiter 510 limits the count of each bin in the blended histogram to a specified range between (G1×step) and (G2×step), where step designates the maximum count in any one bin of the user-defined histogram, and G1, G2 are positive integers with G2>G1. That is, if any one of the bins of the blended histogram has an original count greater than (G2×step), the resulting count of that bin will be decremented to (G2×step) by the histogram limiter 510. Similarly, if any one of the bins of the blended histogram has an original count less than (G₁×step), the resulting count of that bin will be incremented to (G₁×step) by the histogram limiter 510.

Referring also to FIG. 5, the scene change detector 530 calculates the histogram distribution difference between two successive frames and compares the difference with a threshold T. Accordingly, the scene change detector 530 makes a scene change decision (i.e., a scene change is detected in the video sequence) and generates an enabled scene change signal if the difference is greater than the threshold T. Otherwise, the scene change detector 530 will generate a disabled scene change signal. If the state of the scene change signal is enabled, representing any distinctive difference between two adjacent frames, the temporal filter 150 outputs the blended histogram of the current frame. On the other hand, if the state of the scene change signal is disabled, depicting smooth video sequences in time and space, the temporal filter 520 blends the blended histogram of the current frame with that of the preceding frames, bin by bin, to construct a temporal histogram, e.g., weighted factors of the current frame and the preceding frames equal to 0.25 and 0.75 respectively. Afterwards, the temporal filter 520 sends the temporal histogram to the luma remapper 150 for generating the transfer function and remapping.

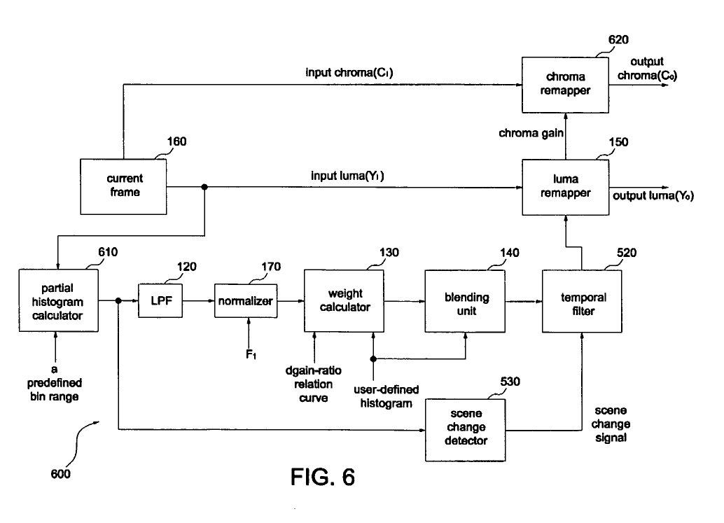

FIG. 6 is a block diagram showing a third embodiment of the invention. Referring to FIG. 6, a dynamic contrast enhancement apparatus 600 comprises a partial histogram calculator 610, a low-pass filter 120, a weight calculator 130, a blending unit 140, a temporal filter 520, a frame buffer 160, a luma remapper 150, a scene detector 530, a chroma remapper 620 and a normalizer 170. The same numerals are used for components identical to the first and the second embodiments, and repeated description is omitted.

In general, the darkest bin of a luma histogram features a low signal-to-noise ratio (SNR) region because it is difficult to distinguish very low luma level signals from noises. Thus, in view of that characteristic, it does not make any sense to enhance the contrast of the darkest region. The partial histogram calculator 610 generates a partial luma histogram for a predefined bin range (e.g., from bin 1 to bin 7 if the total number of luma levels=256) without counting the number of pixels in bin 0 (i.e., an abandoned range). Next, the low-pass filter 120 performs a low-pass filtering operation on the partial luma histogram to generate a filtered histogram. Prior to normalization, the normalizer 170 sets (or limits) the count in bin 0 of the filtered histogram to a predefined constant F₁ for all incoming frames. Then, the normalizer 170 normalizes the filtered histogram from a cumulative total of btotal to (256−F₁) for a predefined bin range (from bin 1 to bin 7). This prevents the bothering of a black bar in a scene as well as over-enhancement of luma contrast. Besides, keeping the count of the darkest region unchanged also improves the perception of contrast and prevents wash-out problems. Basically, the greater the constant F₁ is assigned to the abandoned range (bin 0), the less the remaining output luma levels to be distributed for the predefined bin range (from bin 1 to bin 7). Note that the abandoned range is not limited to bin 0 and, besides, both the constant F₁ and the predefined bin range can be modified.

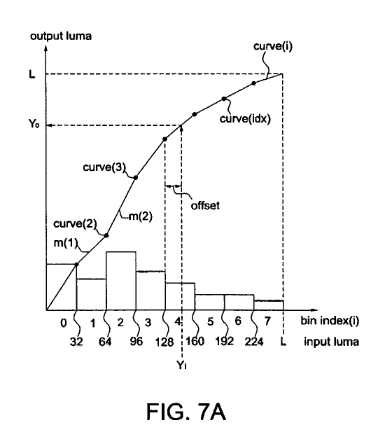

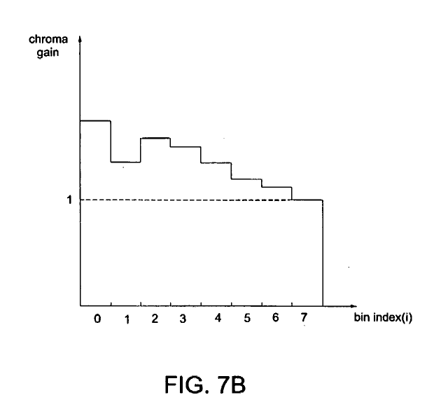

According to the third embodiment, the luma information is also used to enhance chroma contrast, but in a different way from prior arts. According to the transfer function and an input luma level Yᵢ, the luma remapper 150 further generates a chroma gain. Specifically, after obtaining the transfer function, the luma remapper 150 receives an input luma component Yᵢ of an input pixel (or an input image data) and generates a corresponding output luma level Yₒ on a (luma) level by (luma) level basis. Next, the luma remapper 150 makes a modification to a luma gain (Yₒ/Yᵢ) of that pixel in order to generate a chroma gain, on a bin by bin basis, for the chroma component of the same pixel. Consequently, the chroma remapper 620 applies the chroma gain to an input chroma component of the same pixel. An example given in FIGS. 7A-7B is used to demonstrate the operations of both the luma remapper 150 and chroma remapper 620. FIG. 7A illustrates an exemplary temporal histogram and its corresponding transfer function. FIG. 7B shows a relation between the chroma gain and the bin index based on the transfer function curve(i) shown in FIG. 7A.

Suppose L (the whole luma level range)=256 and bsize (the total number of bins)=8, then each bin width=32 luma levels (hereinafter called “width”) for a temporal histogram as shown in FIG. 7A. After receiving the temporal histogram, the luma remapper 150 integrates bin(i) to obtain the transfer function

$$curve ( i ) = {\sum }_{0}^{bsize - 1} bin ( i ) ,$$

given that curve(0)=0 and i is a positive integer and covers the bin range from 1 to (bsize−1). Conceptually, the transfer function curved) is a piecewise linear function as shown by the solid line in FIG. 7A, consisting of straight segments in each bin. Therefore, the slope function for each bin is m(i)=(bin(i)/width), where i is a positive integer and covers the range form 1 to (bsize−1).

According to the third embodiment, an output luma level Yₒ is derived from its corresponding input luma level Yᵢ, two functions curve(i) and m(i) by the luma remapper 150. The output luma level Yₒ can be expressed in an equation form as follows: Yₒ=(curve(idx)+offset×m(idx)), where idx=floor(Yᵢ/width), offset=mod(Yᵢ/width), idx is the closest integer that is less than or equal to (Yᵢ/width) and offset is a remainder from (Yᵢ/width). Since human vision is relatively insensitive to chroma, the chroma gain is generated on a bin by bin basis, thus avoiding over-enhancement of color contrast. Thus, the luma remapper 150 further generates a chroma gain for an input chroma component of an input pixel (or an input image data) according to the transfer function curve(i) and the input luma level Yᵢ of that pixel. The chroma gain can be expressed in an equation form as follows: cg(i)=curve(i+1)/(width×(i+1)), where cg(bsize−1)=1 and i is an integer and covers the range form 0 to (bsize−2). For instance, the chroma gain cg(0)=curve(1)/(width×1)) for the input luma level Yᵢ falling into bin 0 and cg(1)=curve(2)/width×2)) for the input luma level Yᵢ falling into bin 1, etc. As a result, the chroma remapper 620 applies the chroma gain to an input chroma component CJ of the same pixel to obtain its corresponding output chroma level Cₒ=Cᵢ×cg(idx), where idx=floor(Yᵢ/width) and idx is the closest integer that is less than or equal to (Yᵢ/width).

In summary, the invention is an improvement over histogram equalization. Instead of selecting from predetermined transfer functions, the invention generates a one-by-one transfer curve according to image contents, therefore avoiding over-shifting of the mean luma value due to a drastic adjustment.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. An apparatus for dynamic contrast enhancement, comprising:
a histogram calculator for calculating a luma histogram for a current frame;
a low-pass filter coupled to the histogram for performing a low-pass filtering operation on the luma histogram and generating a filtered histogram;
a blending unit coupled to the low-pass filter for blending the filtered histogram with a user-defined histogram and generating a blended histogram according to a blending weight; and
a luma remapper coupled to the blending unit for generating a transfer function according to the blended histogram and applying the transfer function to the current frame.

2. The apparatus according to claim 1, further comprising:
a normalizer coupled between the low-pass filter and the blending unit for normalizing the filtered histogram to a desired luma level range;
wherein the user-defined histogram is also normalized to the desired luma level range.

3. The apparatus according to claim 1, further comprising:
a temporal filter coupled between the blending unit and the luma remapper for either blending the blended histogram of a previous frame with the blended histogram of the current frame if a scene change signal is disabled, or directly outputting the blended histogram of the current frame if the scene change signal is enabled; and
a scene detector for either enabling the scene change signal if a scene change in a video sequence is detected based on a comparison between the luma histogram of the previous frame and the luma histogram of the current frame, or disabling the scene change signal if the scene change in the video sequence is not detected.

4. The apparatus according to claim 1, further comprising:
a chroma remapper coupled to the luma remapper for applying a chroma gain to an input chroma component of a pixel;
wherein the luma remapper further generates the chroma gain on a bin by bin basis according to the transfer function and an input luma component of the same pixel.

5. The apparatus according to claim 1, further comprising:
a weight calculator coupled between the low-pass filter and the blending unit for generating the blending weight according to the filtered histogram and the user-defined histogram.

6. The apparatus according to claim 5, wherein the weight calculator generates the blending weight according to a first count in the bins of the filtered histogram, a second count in the bins of the user-defined histogram and a blending parameter.

7. The apparatus according to claim 6, wherein the blending parameter is generated according to a pre-defined dgain-ratio relation curve and a ratio of the first count in the bins of the filtered histogram to the second count in the bins of the user-defined histogram.

8. The apparatus according to claim 6, wherein the first count is selected within a range from the maximum count to the Nₜₕ maximum count in the bins of the filtered histogram, where N is a positive integer and N is equal to a total number of the bins of the filtered histogram divided by three.

9. The apparatus according to claim 6, wherein the second count is selected within a range from the maximum count to the Pₜₕ maximum count in the bins of the user-defined histogram, where P is a positive integer and P is equal to a total number of the bins of the user-defined histogram divided by three.

10. The apparatus according to claim 6, wherein the first count is a mean of a range from the Mₜₕ maximum count to the Nₜₕ maximum count in the bins of the filtered histogram, wherein N is equal to a total number of the bins in the filtered histogram divided by three, and wherein N and M are positive integers and N>M.

11. The apparatus according to claim 6, wherein the second count is a mean of a range from the Qₜₕ maximum count to the Pₜₕ maximum count in the bins of the user-defined histogram, wherein P is equal to a total number of the bins of the user-defined histogram divided by three, and wherein P and Q are positive integers and P>Q.

12. The apparatus according to claim 1, further comprising:
a histogram limiter coupled to the blending unit for limiting both the maximum count and the minimum count for each bin of the blended histogram, wherein the blending weight is equal to a first constant.

13. The apparatus according to claim 1, wherein the histogram calculator further generates a partial luma histogram according to a predefined bin range, and wherein the partial luma histogram is made up of a plurality of bins.

14. The apparatus according to claim 13, further comprising:
a normalizer coupled between the low-pass filter and the blending unit for setting the magnitude of a bin out of the predefined bin range to a second constant for the filtered histogram, normalizing the filtered histogram for the predefined bin range to a desired luma level range minus the second constant.

15. The apparatus according to claim 14, wherein the bin out of the predefined bin range is the darkest bin of the filtered histogram.

16. A method for dynamic contrast enhancement, comprising the steps of:
calculating a luma histogram for a current frame;
performing a low-pass filtering operation on the luma histogram to generate a filtered histogram;
blending the filtered histogram with a user-defined histogram to generate a blended histogram;
generating a transfer function according to the blended histogram; and
applying the transfer function to the current frame.

17. The method according to claim 16, wherein the step of performing further comprises:
normalizing the filtered histogram and the user-defined histogram to a desired luma level range.

18. The method according to claim 16, the step of performing further comprises:
enabling a scene change signal if a scene change in a video sequence is detected based on a comparison between the luma histogram of the previous input frame and the luma histogram of the current frame, or disabling the scene change signal if the scene change in the video sequence is not detected; and
blending the blended histogram of a previous frame with the blended histogram of the current frame if the scene change signal is disabled, or directly outputting the blended histogram of the current frame if the scene change signal is enabled.

19. The method according to claim 16, further comprising the steps of:
generating a chroma gain on a bin by bin basis according to the transfer function and an input luma component of a pixel; and
applying the chroma gain to an input chroma component of the same pixel.

20. The method according to claim 16, wherein the step of performing further comprises:
generating the blending weight according to the filtered histogram and the user-defined histogram.

21. The method according to claim 20, wherein the blending weight is generated according to a first count in the bins of the filtered histogram, a second count in the bins of the user-defined histogram and a blending parameter.

22. The method according to claim 21, wherein the blending parameter is generated according to a pre-defined dgain-ratio relation curve and a ratio of the first count in the bins of the filtered histogram to the second count in the bins of the user-defined histogram.

23. The method according to claim 21, wherein the first count is selected within a range from the maximum count to the Nₜₕ maximum count in the bins of the filtered histogram, where N is a positive integer and N is equal to a total number of the bins of the filtered histogram divided by three.

24. The method according to claim 21, wherein the second count is selected within a range from the maximum count to the Pₜₕ maximum count in the bins of the user-defined histogram, where P is a positive integer and P is equal to a total number of the bins of the user-defined histogram divided by three.

25. The method according to claim 21, wherein the first count is a mean of a range from the Mₜₕ maximum count to the Nₜₕ maximum count in the bins of the filtered histogram, wherein N is equal to a total number of the bins in the filtered histogram divided by three, and wherein N and M are positive integers and N>M.

26. The method according to claim 21, wherein the second count is a mean of a range from the Qₜₕ maximum count to the Pₜₕ maximum count in the bins of the user-defined histogram, wherein P is equal to a total number of the bins of the user-defined histogram divided by three, and wherein P and Q are positive integers and P>Q.

27. The method according to claim 16, wherein the step of blending further comprises:
limiting both the maximum count and the minimum count for each bin of the blended histogram, wherein the blending weight is equal to a first constant.

28. The method according to claim 16, wherein the step of calculating further comprises:
generating a partial luma histogram according to a predefined bin range, and wherein the partial luma histogram is made up of a plurality of bins.

29. The method according to claim 28, wherein the step of performing further comprises:
setting the magnitude of a bin out of the predefined bin range to a second constant for the filtered histogram; and
normalizing the filtered histogram for the predefined bin range to a desired luma level range minus the second constant.

30. The method according to claim 29, wherein the bin out of the predefined bin range is the darkest bin of the filtered histogram.
